(19) United States
(12) Patent Application Publication
(10) Pub. No.: US 2023/0000103 A1
(43) Pub. Date: Jan. 5, 2023

(54) FOOD PRODUCT

(71) Applicant: SOREMARTEC S.A., Senningerberg (LU)

(72) Inventor: Sergio MANSUINO, Castiglione Falletto (CN) (IT)

(73) Assignee: SOREMARTEC S.A., Senningerberg (LU)

(21) Appl. No.: 17/781,564

(22) PCT Filed: Nov. 20, 2020
(86) PCT No.: PCT/IB2020/060972

§ 371 Date: Jun. 1, 2022

(30) Foreign Application Priority Data
Dec. 6, 2019 (IT) 102019000023238

(51) Int. Cl. A23G 3/54; A23G 1/00; A23G 1/54; A23G 3/34; A23G 3/20

(52) U.S. Cl. CPC A23G 3/54; A23G 1/0076; A23G 1/54; A23G 3/0065; A23G 3/2007

(57) ABSTRACT

Described herein is a food product comprising a solid chocolate body (2) having an outer surface. The product is characterized in that it comprises a closed wafer shell (4), containing said chocolate body (2) inside it.

The present invention relates to a food product of the type comprising a solid chocolate body having an outer surface.

Products forming the subject of the solution described herein are, for example, chocolates or pralines.

In particular, the present invention regards a new solution of product of the type in question that presents a series of advantages as will be seen in detail in what follows.

In general, the solution described herein regards a food product according to claim 1 and a method of production of food products according to claim 9.

The claims provided in what follows form an integral part of the technical teaching provided herein.

Further characteristics and advantages of the invention will emerge clearly from the ensuing description with reference to the annexed drawings, which are provided purely by way of non-limiting example and in which:

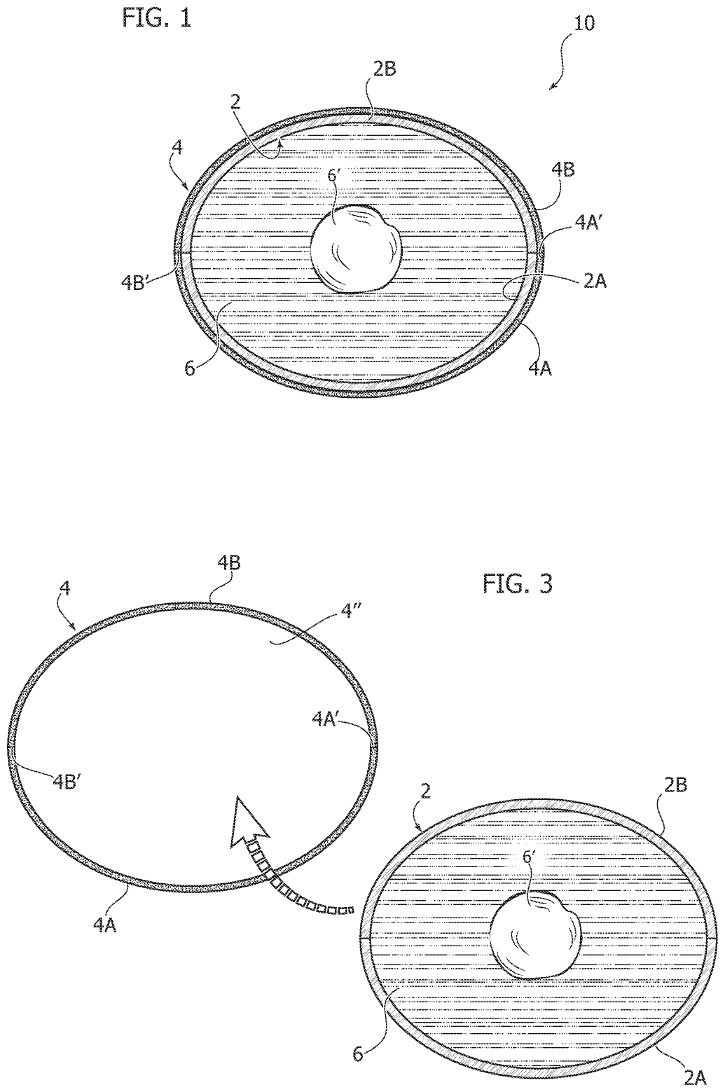

FIG. 1 illustrates a cross-sectional view of an example of the confectionery product described herein;

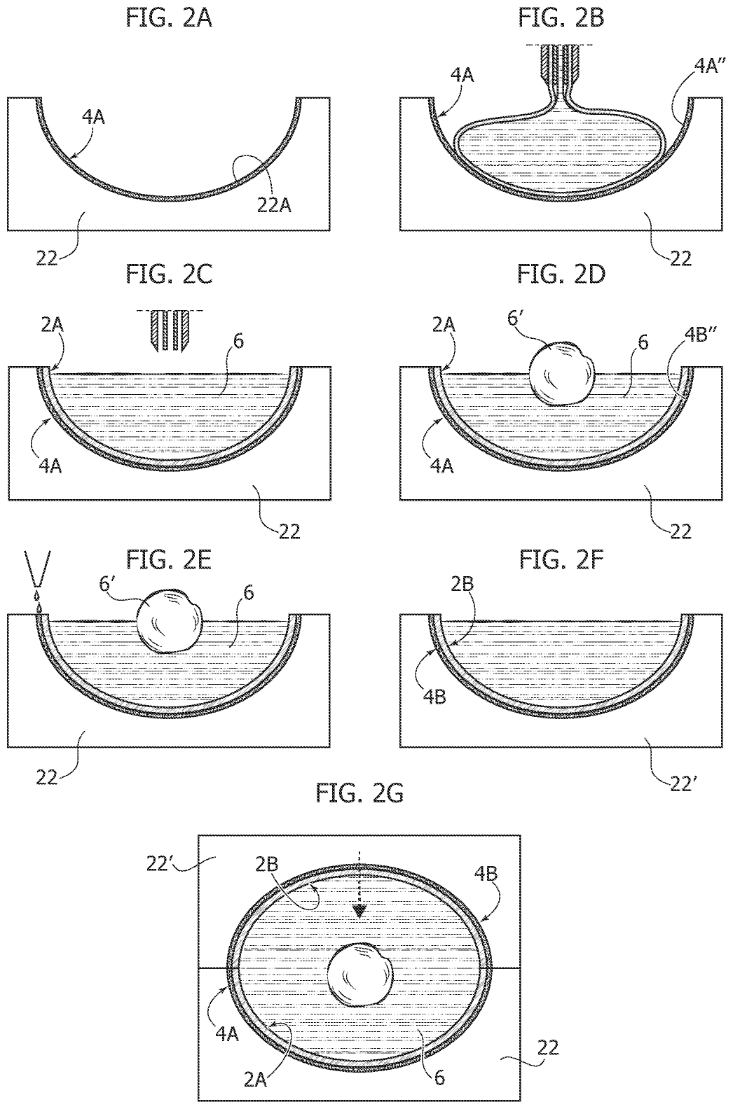

FIGS. 2A to 2G are schematic illustrations of successive steps of an example of method for the production of the food product illustrated in FIG. 1; and

FIG. 3 is an exploded view of the product of FIG. 1.

Illustrated in the ensuing description are various specific details aimed at providing an in-depth understanding of the embodiments. The embodiments may be obtained without one or more of the specific details, or with other methods, components, or materials, etc. In other cases, known structures, materials, or operations are not illustrated or described in detail so that various aspects of the embodiment will not be obscured.

The references used herein are provided merely for convenience and hence do not define the sphere of protection or the scope of the embodiments.

In general, the food product described herein comprises a body made of solid chocolate having an outer surface.

In its final form, the chocolate body may effectively be a chocolate product of any type, for example, a chocolate, a praline, a bar, etc. The chocolate body in question may hence present either as a full chocolate body, or else as a hollow chocolate body, for example a chocolate shell, containing in turn a generic filling, either sweet or savoury, for example, fruit, preparations of various nature (for example, creams, meringue, etc.), biscuits, etc.

The food product described herein is characterized in that it further comprises a closed wafer shell, containing the chocolate body inside it.

The wafer shell constitutes a casing designed to enclose the chocolate body.

The wafer shell constitutes, in general, a physical/mechanical barrier designed to protect the chocolate body.

In particular, the wafer shell constitutes, first of all, a protective layer that also provides a contribution of thermal insulation for the chocolate body with respect to the external environment.

In this way, the effects of melting of the chocolate contained in the shell, deriving from the action of the environmental heat at high temperatures, for example above 24° C.-25° C., as may be encountered in summer periods or in hot countries, are reduced.

It should be noted, in this connection, that today the consumption of chocolate products is limited in time and also geographically, according to the weather conditions, generally avoiding consumption when the temperature is above 24-25° C.

Instead, thanks to the wafer shell, the product described herein may be sold all year round and in any geographical context.

Moreover, the wafer shell also constitutes a physical barrier between the chocolate body and the external environment, which is able to prevent contamination of the chocolate body from external agents.

On the other hand, the presence of the wafer shell facilitates handling of the product by the consumer. In fact, given that contact with the product is through the wafer and is not directly with the chocolate, this prevents consumers from getting their hands dirty with chocolate and prevents the heat of the hands from melting the chocolate.

Finally, it should be noted that the wafer shell withholds within it any possible filling leaking from the chocolate body, thus safeguarding the integrity of the product and preventing the outer region that receives the product from getting dirty.

In view of the foregoing, as compared with conventional chocolate products, the product described herein is stronger and easier to handle and preserve, above all with particular reference to an industrial packaging and distribution chain.

The wafer shell defines inside it a cavity that receives the chocolate body.

Preferably, the inner surface of the wafer shell that delimits the aforesaid cavity is shape-fitted with the outer surface of the chocolate body.

In this way, the chocolate body is kept stationary in position within the wafer shell by the wafer shell itself.

There is hence not envisaged the use of any additional material for connecting the chocolate body and the wafer shell together.

It should now be noted that the term “wafer” is used in the present description to indicate a sheet shaped in any way, resulting from forming and baking of a dough or batter for oven-baked products. This term is hence not to be understood as in any way limiting the nature of the ingredients used for the dough; the wafer referred to may, for example, in fact, be a wafer obtained from a conventional wafer batter or else a wafer of bread obtained according to a leavening process.

By way of example, the recipe of the dough may comprise the following ingredients (the amounts referred to are expressed as weight percentages with respect to the total weight of the dough):
42%-39% wheat flour;
52%-49% water;
5%-10% sugar;
5%-10% milk;
2%-4% oil;
less than 1% soy lecithin;
less than 1% salt; and
less than 1% sodium bicarbonate.

The recipe of the dough may in any case be varied according to the type of product to be obtained so that the taste of the wafer is always calibrated on the taste and flavour of the other ingredients envisaged.

The thickness of the shell may be selected on the basis of the strength required. Preferably, it is comprised between 1 mm and 2 mm, even more preferably between 1.60 mm and 1.90 mm

As mentioned above, preferably between the inner surface of the wafer shell and the outer surface of the chocolate product a shape fit is obtained.

The above shape fit is configured in such a way that the chocolate product is kept stationary in position by the wafer shell itself.

Preferably, the shape fit is obtained according to a configuration in which the volume defined by the inner surface of the wafer shell corresponds to the total volume of the chocolate product and in which the outer surface of the chocolate product is entirely in contact with the inner surface of the wafer shell.

In general, the shape of the wafer shell depends upon the shape of the chocolate product. Preferably, the wafer shell is formed by a first part and a second part that are coupled together along respective edges set in mutual contact. According to the shape of the chocolate product, the two parts of the wafer shell may each have a hollow conformation, planar or else concave.

Preferably, the edges in mutual contact of the two parts of the wafer shell are connected together via a welding operation using water. An example of method to obtain this type of weld is described in the patent application WO2013108206, filed in the name of the present applicant. This patent document describes application of water on the edges to be welded together. Alternatively, it is possible to envisage the use of water vapour or ice crystals.

The above modality of connection prevents the need to insert between the edges of the two parts of wafer additional material with an adhesive function, which would interrupt the insulating shield defined by the wafer thus jeopardizing contribution to thermal insulation obtained by the wafer shell in regard to the chocolate product.

With reference now to FIGS. 1 and 3, these illustrate an example of the confectionery product described herein.

The product illustrated in the above figures, designated as a whole by the reference number 10, comprises a chocolate product constituted by a praline 2, and a closed wafer shell 4, which surrounds the praline 2.

The praline 2 has a substantially spherical conformation.

The wafer shell 4 is formed by two half-shells 4A, 4B, both having a cap-like conformation, which are coupled together at the respective mouth edges 4A′, 4B′.

The two coupled half-shells 4A, 4B define internally a cavity 4′ having a shape and size that are the same as those of the praline 2, and the outer surface of the latter is entirely in contact with the inner surface of the wafer shell 4.

As a whole, the praline 2 is withheld by the two half-shells 4A, 4B so as to be prevented from moving inside the closed shell formed by the half-shells.

The mouth edges 4A′, 4B′ of the two half-shells are fixed together by means of a welding operation using water.

In a way in itself known, the praline 2 is in turn formed by two chocolate half-shells 2A, 2B joined together and containing within them a filling 6, represented, by way of example, as having the appearance of a cream. In the example illustrated, the praline 2 moreover contains an inclusion 6′, such as for example a hazelnut.

As anticipated above, the solution described herein moreover regards a method for obtaining the food product described above.

In general, the method comprises the following steps:
providing a first wafer-shell part having a cavity for housing a chocolate product;
dispensing melted chocolate within the aforesaid cavity and moulding said chocolate to form the chocolate product; and
providing a second wafer-shell part and applying said second wafer part on the first wafer part containing the chocolate, to form a closed wafer shell.

The method described herein is hence characterized in that at least one wafer-shell part is used as mould for forming the chocolate product.

This considerably simplifies production of the product, and moreover facilitates provision of the shape fit described above, between the wafer shell and the chocolate product.

By way of example, FIGS. 2A-2G illustrate an embodiment of the method described herein for obtaining the food product 10 of FIG. 1.

Starting from FIG. 2A, the method envisages feeding one of the two half-shells of the wafer shell 4, in the example illustrated the half-shell 4A, along a production line.

In the example illustrated, the half-shell 4A is carried by a mould 22 provided with a cavity 22A in which the half-shell 4A is received.

Use of the mould 22 makes it possible to have a precise control over the position and orientation in space of the half-shell 4A. Use of such a mould is not in any case essential for the purposes of implementation of the method described herein.

The method envisages dispensing melted chocolate that will come to form the half-shell 2A of the praline 2, into the internal cavity 4A″ of the half-shell 4A (FIG. 2B), and moulding it.

In the example illustrated, this forming operation is obtained through a one-shot process, which envisages simultaneous dispensing of the chocolate and of the filling 6 (FIGS. 2B and 2C).

In general, the operation of forming of the chocolate may in any case be of any known type that envisages carrying out moulding of the chocolate within a mould cavity. For instance, as an alternative to the one-shot process referred to, it is possible to envisage an operation of forming via trickling.

In any case, as now emerges clearly, in the method described herein the mould cavity referred to above for moulding the chocolate will be constituted by the internal cavity of the wafer shell or half-shell.

It should be noted that, as soon as the chocolate half-shell 2A is formed, it is in a condition of perfect coupling with the wafer half-shell 4A that contains it.

Next, the method envisages applying water (in the form of a liquid, or water vapour, or ice crystals) along the mouth edge 4A′ of the half-shell 4A (FIG. 2E) to obtain welding using water of this half-shell with the other half-shell 4B. Also the latter is fed along the production line, and is subjected to the same steps of dispensing and forming of the chocolate described previously, so as to reach the half-shell 4A, with the chocolate half-shell 2B and the filling 6 inside its own cavity 4B″, as illustrated in FIG. 2F.

The modality of application of the water on the mouth edge 4A′ may be the same as the one that is described in the patent document WO2013108206, filed in the name of the present applicant.

Incidentally, it should be noted that application of the water on the edge of the half-shell may be performed also in a previous stage, for example before deposition of the filling 6 or else even before dispensing and moulding of the chocolate.

Finally, the method envisages coupling together the two wafer half-shells 4A, 4B, thus forming the closed shell 4 (FIG. 2G).

Thanks to the shape fit that is obtained between the wafer shell and the chocolate shell, mutual contact of the two wafer half-shells also brings about simultaneously coupling between the two chocolate half-shells 2A, 2B and hence completion of the praline 2.

In particular, the two wafer half-shells press the two chocolate half-shells against one another, and these are in this way held together, without any need to envisage any further step of welding or connection of the two.

It should be noted that the welding operation using water referred to above provides the advantage of reducing to a minimum the amount of water used so as to prevent weakening of the wafer structure or jeopardize the quality of the chocolate. In any case, other modalities of welding using water may be envisaged for implementing the method described herein.

As already discussed previously, the shape of the wafer shell 4 depends upon the shape of the chocolate product. In the example illustrated, the spherical shape of the shell 4, and consequently the cap shape of the two half-shells 4A and 4B, derives from the spherical shape of the praline 2.

In other applications in which, for example, the chocolate product has a flat bottom, the wafer shell 4 may, instead, be formed by just one part with hollow conformation (or half-shell part) and by another with planar conformation.

In this case, the chocolate product may be obtained entirely only within the hollow part of the wafer shell. The other, planar, part of the wafer shell may be applied on the hollow part, only after the chocolate product has been formed therein.

It should again be noted that in applications in which the chocolate body is constituted by a chocolate, the moulding step may envisage mere dispensing of melted chocolate in the cavity of the wafer shell or half-shell, and subsequent hardening of the chocolate. Also in this case, moulding of the chocolate may be performed within each of the two parts of the wafer shell or else in just one of these.

Of course, without prejudice to the principle of the invention, the details of construction and the embodiments may vary, even significantly, with respect to what has been illustrated herein purely by way of non-limiting example, without thereby departing from the scope of the invention, as defined by the annexed claims.

1. A food product comprising a chocolate body (2) having an outer surface,
characterized in that it comprises a closed wafer shell (4), containing said chocolate body (2) inside it.

2. The product according to claim 1, wherein said wafer shell has an inner surface that is shape-fitted with the outer surface of said chocolate body.

3. The product according to claim 1, wherein said closed wafer shell (4) comprises a first portion and a second portion (4A, 4B) coupled together, through respective edges (4A′, 4B′) set in mutual contact, to obtain said closed wafer shell (4).

4. The product according to claim 3, wherein said edges (4A′, 4B′) are connected together as a result of a welding operation.

5. The product according to claim 4, wherein said welding operation is a welding operation using water.

6. The product according to claim 1, wherein said chocolate body (2) is formed by a chocolate shell containing a filling (6) inside it.

7. The product according to claim 6, wherein said filling, which may be sweet or savoury, can be selected from among the following: fruit, preparations of various nature (for example, creams, meringue, etc.), granular material of any type, biscuits, etc.

8. The product according to claim 1, wherein said chocolate body is formed by a body full of chocolate.

9. The product according to claim 1, wherein said chocolate body is a chocolate shell that coats a plurality of layers, which are sweet and/or savoury.

10. The product according to claim 1, wherein said wafer shell (4) has walls of a thickness comprised between 1 mm and 5 mm, preferably between 1.60 mm and 1.90 mm.

11. A method for obtaining a food product according to claim 1 any one of the preceding claims, comprising:
providing a first part (4A) of said wafer shell (4) having a cavity (4A″) for housing said chocolate product (2);
dispensing melted chocolate within said cavity and moulding said chocolate to form said chocolate product; and
providing a second part (4B) of said wafer shell and applying said second wafer part (4B) on said first wafer part (4A) having said housing cavity (4A″) that contains said chocolate, to form said wafer shell (4).

12. The method according to claim 11, wherein said step of moulding said chocolate comprises carrying out a moulding process of the one-shot type within said housing cavity (4A″).

13. The method according to claim 11, wherein providing said first wafer part and said second wafer part includes providing said first and second parts having respective edges (4A′, 4B′) configured to be set in mutual contact,
said method including carrying out a welding operation for connecting said edges together.

14. The method according to claim 13, wherein said welding operation envisages applying a given amount of water on the edge of said first wafer part and/or said second wafer part, before coupling said second wafer part (4B) and said first wafer part (4A) together.

15. The method according to claim 14, wherein said step of applying a given amount of water includes applying water in the form of liquid, or else in the form of water vapour, or again in the form of ice crystals.

16. The method according to claim 11, wherein providing said second part (4B) of said wafer shell (4) includes:
providing said second part (4B) of said wafer shell (4) having a cavity (4B″) for housing said chocolate product (2); and
dispensing further melted chocolate (2B) within said cavity (4B″) and moulding said further chocolate;
wherein said step of applying said second wafer part (4B) on said first wafer part (4A) includes coupling together said moulded chocolate (2A) and said further moulded chocolate (2B), to form said chocolate body (2).
